(19) United States
(12) Patent Application Publication
(10) Pub. No.: US 2016/0276851 A1
(43) Pub. Date: Sep. 22, 2016

(54) SYSTEM AND METHOD FOR MANAGING BATTERIES USED IN A DISTRIBUTED FACILITY

(71) Applicant: UNITRONICS AUTOMATED SOLUTIONS LTD., Ben Gurion Airport (IL)

(72) Inventor: Haim SHANI, Shoham (IL)

(21) Appl. No.: 15/070,067

(22) Filed: Mar. 15, 2016

Related U.S. Application Data
(60) Provisional application No. 62/133,521, filed on Mar. 16, 2015.

(51) Int. Cl. H02J 7/00

(52) U.S. Cl. CPC H02J 7/0021; H02J 7/007

(57) ABSTRACT

A monitoring system for battery powered devices, comprising at least one power storage element, configured to power a battery powered device, a central control unit, operably coupled to the at least one power storage element, and at least one sensor, operably coupled to the at least one power storage element and configured to measure at least one operational parameter of the at least one power storage element and send the measured at least one parameter to the central control unit, wherein the central control unit is configured to send control commands to the at least one power storage element, and wherein the central control unit is configured to control the charging time of the at least one power storage element.

### CROSS REFERENCE TO RELATED APPLICATION

This application claims the benefit of U.S. Provisional Patent Application No. 62/133,521, filed Mar. 16, 2015, which is incorporated herein by reference.

### FIELD OF THE INVENTION

The present invention relates to power storage management. More particularly, the present invention relates to systems and methods for managing batteries in a distributed facility.

### BACKGROUND OF THE INVENTION

Battery operated articles, such as machinery, tools, trolleys and other similar devices, are typically operated in a single location, and by a single operator. A single operator may operate such articles in more than one location, in each of which there may be multiple units (or devices) that are operated by electrical batteries.

Batteries are usually an expensive power source that require periodical recharging, and efficient operation of which requires close monitoring of various characteristics. Such characteristics include monitoring the operation efficiency of the batteries, the length of operation period before a recharge may be required, the magnitude of exhaustion of the battery before a recharge may be required, the number of possible charges before the battery needs to be disposed of, the operation voltage, the operation current and the operation temperature, etc.

When a large number of batteries (or battery clusters) is managed by a single operator there is a need to enable the operator to optimize the usage and maintenance of the batteries, thereby saving money, maintenance time and work time for instance by reducing the number of battery replacements.

### SUMMARY OF THE INVENTION

There is thus provided, in accordance with a preferred embodiment of the invention, a monitoring system for battery powered devices, the system comprising at least one power storage element, configured to power a battery powered device, a central control unit, operably coupled to the at least one power storage element, and at least one sensor, operably coupled to the at least one power storage element and configured to measure at least one operational parameter of the at least one power storage element and send the measured at least one parameter to the central control unit, wherein the central control unit is configured to send control commands to the at least one power storage element, and wherein the central control unit is configured to control the charging time of the at least one power storage element.

Furthermore, in accordance with a preferred embodiment of the present invention, the central control unit comprises a computing unit that is configured to allow analysis of information.

Furthermore, in accordance with a preferred embodiment of the present invention, the central control unit further comprises a memory unit.

Furthermore, in accordance with a preferred embodiment of the present invention, the at least one sensor comprises a temperature sensor.

Furthermore, in accordance with a preferred embodiment of the present invention, the at least one sensor further comprises an electric current sensor.

Furthermore, in accordance with a preferred embodiment of the present invention, the system further comprises a network connection, configured to allow data transfer between the at least one power storage element and the central control unit.

Furthermore, in accordance with a preferred embodiment of the present invention, the system further comprises a user's control terminal capable of displaying monitoring information of the at least one power storage element.

Furthermore, in accordance with a preferred embodiment of the present invention, the user's control terminal capable of analyzing commands and data entered by the user.

Furthermore, in accordance with a preferred embodiment of the present invention, the central control unit is further configured to control the charging and discharging current of the at least one power storage element.

Furthermore, in accordance with a preferred embodiment of the present invention, the central control unit is further configured to provide an indication when the at least one power storage element exceeds predefined parameters.

Furthermore, in accordance with a preferred embodiment of the present invention, the system further comprises a management unit operably coupled to the central control unit and to the at least one power storage element, wherein the management unit is configured to allow monitoring of the at least one power storage element.

Furthermore, in accordance with a preferred embodiment of the present invention, a method for monitoring battery powered devices is provided, the method comprising providing at least one power storage element, configured to power a battery powered device, providing a central control unit, operably coupled to the at least one power storage element, providing at least one sensor, operably coupled to the at least one power storage element, measuring parameters of the at least one power storage element, sending the measured parameters to the central control unit, and sending control commands to the at least one power storage element, wherein control commands sent to the at least one power storage element comprises operation orders to modify charging time.

Furthermore, in accordance with a preferred embodiment of the present invention, the method further comprises displaying measured parameters to the user.

Furthermore, in accordance with a preferred embodiment of the present invention, the method further comprises analyzing data of measured parameters.

Furthermore, in accordance with a preferred embodiment of the present invention, the method further comprises measuring temperature with the at least one temperature sensor.

Furthermore, in accordance with a preferred embodiment of the present invention, the control commands are sent via a network connection.

Furthermore, in accordance with a preferred embodiment of the present invention, the method further comprises displaying monitoring information of the at least one power storage element.

Furthermore, in accordance with a preferred embodiment of the present invention, the method further comprises analyzing commands and data entered by the user.

Furthermore, in accordance with a preferred embodiment of the present invention, the method further comprises controlling the charging and discharging current of the at least one power storage element.

Furthermore, in accordance with a preferred embodiment of the present invention, the method further comprises providing an indication when the at least one power storage element exceeds predefined parameters.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A schematically illustrates a block diagram of a monitoring system, generally designated 100, for a local facility, according to an embodiment of the present invention;

FIG. 1B schematically illustrates a block diagram of the local facility, according to an embodiment of the present invention; and

FIG. 2 shows a flow diagram of steps performed by a system, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

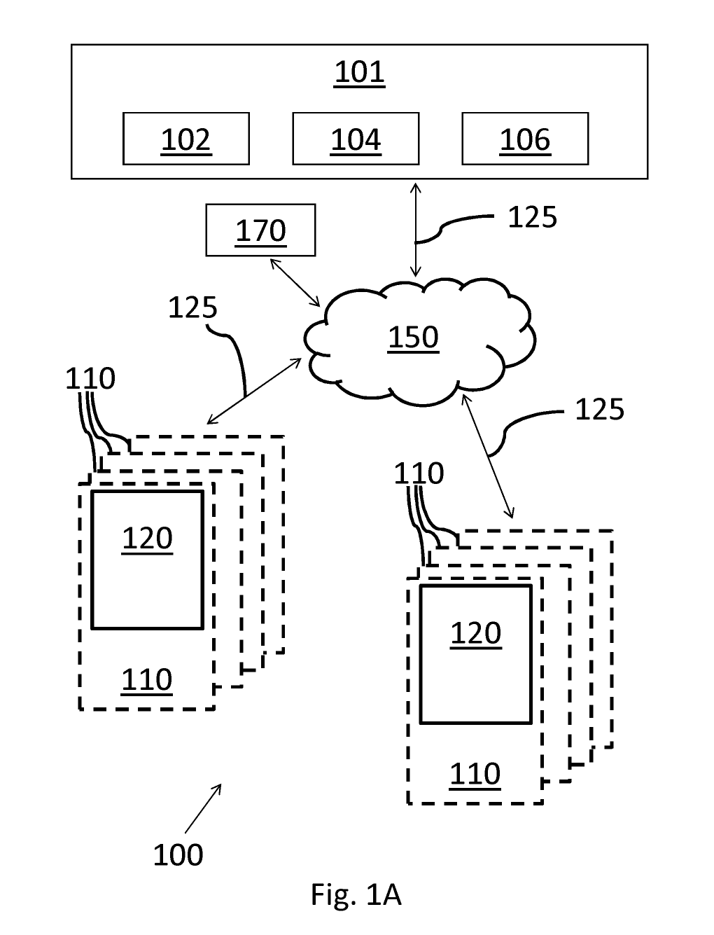

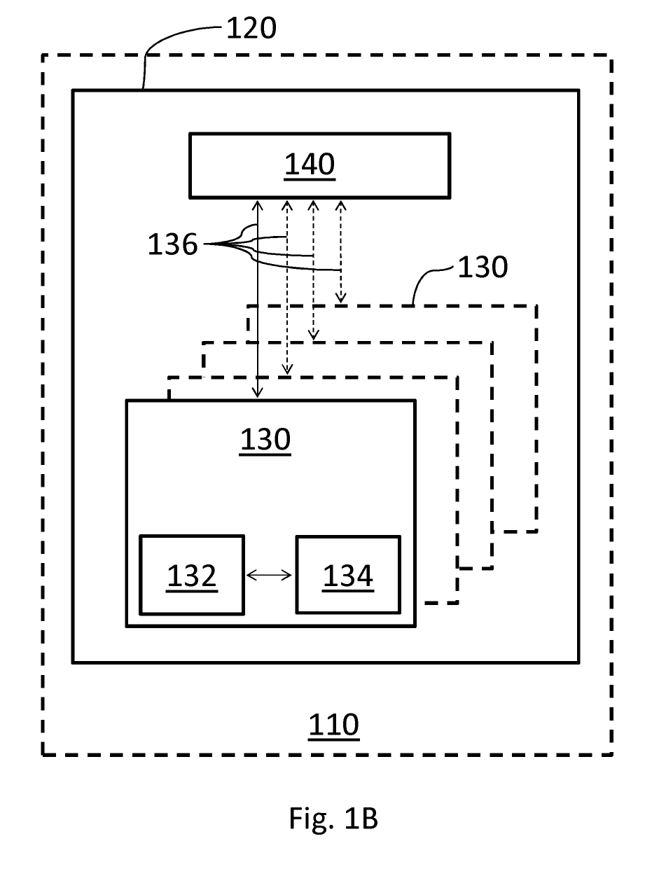

Reference is now made to FIGS. 1A-1B, which show a system for management of a plurality of batteries in a distributed facility (wherein the direction of arrows indicates the direction of information flow), according to some embodiments of the invention. FIG. 1A schematically illustrates a block diagram of a monitoring system, generally designated 100, for a local facility 110. FIG. 1B schematically illustrates a block diagram of the local facility 110.

Monitoring system 100 may be configured to manage articles associated with one or more local facilities 110, these facilities 110 including factories, storage hangars, parking lots and the like. Local facility 110 may in turn comprise a local managed group of articles 120 comprising a plurality of battery powered apparatuses 130 (e.g. machinery operating with Lithium-Ion batteries) and a facility system management unit 140, as further described hereinafter. It should be noted that a plurality of local facilities 110 is indicated with a dashed line.

For example, a monitoring system 100 that monitors three factories 110, wherein each factory 110 has two machines 120, and each machine 120 has ten independent battery powered robots 130.

Monitoring system 100 may further comprise a central control unit 101. Central control unit 101 may comprise a computing unit 102 (such as a controller), a memory unit 104 and a data storage unit 106 in operative communication between them. It is appreciated that computing unit 102 may comprise a processor that is capable of carrying out computation and analysis of information stored at central control unit 101.

It should be noted that memory unit 104 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Moreover, memory unit 104 may be or may include a plurality of, possibly different memory units.

It is appreciated that storage unit 106 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage unit 106 and may be loaded from storage unit 106 into memory unit 104 where it may be processed by controller 102.

In some embodiments, some of the components shown in FIGS. 1A and 1B may be omitted. For example, memory unit 104 may be a non-volatile memory having the storage capacity of data storage unit 106. Accordingly, although shown as a separate component, data storage unit 106 may be embedded or included in memory unit 104. Furthermore, data storage unit 106 may store programs and data that when loaded to memory unit 104 and executed by computing unit 102 may perform the operations according to some embodiments of the invention, as further described hereinafter.

According to some embodiments, local facilities 110 may be managed via central control unit 101. In some embodiments, facility system management unit 140 (at each local facility 110) may be in operative communication with central control unit 101 via an available communication network 150 (for instance a cloud based network), and via communication channels 125. Thus, central control unit 101 may be operably coupled to every local facility 110 in the system, and specifically every element of each local facility 110, for example a battery powered article within a local facility 110 that is managed by facility system management unit 140. It should be noted that communication channels 125 may comprise wired and/or wireless transfer of information.

According to some embodiments, battery powered apparatus 130 may comprise one or more battery packs 132 with a plurality of batteries (e.g., Lithium-Ion batteries), and an apparatus battery management unit 134 in operative communication with battery pack 132 (as shown in FIG. 1B). It is appreciated that battery management unit 134 may comprise at least one sensor (not shown) that is configured to detect the state of the battery, for instance a temperature sensor or a voltage meter. It should be noted that a plurality of battery powered apparatuses 130 is indicated with a dashed line.

According to some embodiments, monitoring system 100 may further comprise a user's control terminal 170 that is configured to allow displaying information to the operator, as well as inputting commands and data, as may be needed (e.g. with a dedicated user interface). For example, an operator having a computerized device with a user's control terminal display 170 (e.g., a smartphone) may connect via network 150 to central control unit 101, and thereby receive information regarding warnings for battery packs 132 in a particular battery powered apparatus 130 inside a specific local facility 110.

In some embodiments, apparatus battery management unit 134 may be in operative communication with facility system management unit 140 via communication channels 136, so as to provide information indicative of the operation parameters and health of the respective battery pack 132. In some embodiments, communication channels 136 comprise wired and/or wireless transfer of information.

Such information may comprise recurring indications of the time of beginning of current operation cycle of battery powered apparatus 130, the voltage of battery pack 132, the momentary current provided by battery pack 132, the temperature of battery pack 132, the calculated or measured amount of remaining consumable electrical charge in battery pack 132, the momentary level of charge of battery pack 132 (when in charge phase), the length of charging period, the number of operations since last charge, the total number of recharges of battery pack 132, similar parameters relating to the battery pack and/or the charging or a combination thereof. It should be noted that batteries managed by monitoring system 100 may be charged by a facility external to monitoring system 100, for example a commercially available charger connected to a household electrical grid.

In some embodiments, temperature monitoring may prevent operating at over heating or under heating conditions. For example, upon indication of battery temperature exceeding a predefined value, the operator may initiate corresponding operation of a dedicated fan to lower the temperature.

In some embodiments, voltage monitoring may for instance prevent operating with overvoltage above a predefined value during charging of the battery. In some embodiments, battery voltage within a battery pack may be adjusted in order to prevent overvoltage in the battery pack. It is appreciated that by operating in a predefined working range for the battery (e.g., specific voltage and temperature), the lifetime of the batteries may be extended.

In some embodiments, facility system management unit 140 may provide to central control unit 101 information relating to at least one of the status of the batteries, the optimal timing for charging, remaining number of operations possible with current state of batteries, etc. Moreover, when the charging time of the various packs is optimized throughout the system (i.e., in all facilities), the overall operation may be optimized due to lower down-time of the system.

According to some embodiments, the status of a single cell within battery pack 132 may also be monitored. Thus, the combined monitoring of all single cells may contribute to the overall control of the system since the operator may receive further layer of information, for instance indication of a single cell malfunction within an operating battery pack may not affect the over-all operation. In another example, in battery pack providing individual control of each of the cells, the malfunctioning cell may be disconnected from the other cells in the pack thereby allowing further operation of the battery pack (with less power) instead of immediate shutdown of the battery powered article.

For example, an operator receiving an indication that a specific battery pack has low power may decide to reschedule the charging of that battery pack with a different device carrying out the operation instead of that being recharged. Optionally, various operation schemes may be predefined by the operator so as to allow the system to automatically optimize the operation, for instance provide a charging algorithm to reschedule the charging of battery packs when required, or controlling a fan to cool the batteries when measured battery temperature exceeds a predefined value.

In some embodiments, facility system management unit 140 may also provide to central control unit 101 information relating to operations carried out during charging of the batteries. For example, initiation time of charging, value of current during charging, stopping time of charging and the like, so as to provide additional control options to the operator.

In some embodiments, a battery powered apparatus may be operated or controlled to shut off or prevent certain operations in order to prevent battery operation exceeding predefined working range. For example, a battery powered shuttle cart shutting down backlight to preserve battery.

According to some embodiments, facility system management unit 140 may receive required operations to be performed by battery powered apparatuses 130 (e.g., at a predetermined time in the future) and may coordinate, manage and control assignment of such operations to at least one specific battery powered apparatus 130 so as to control and optimize usage of battery packs 132, to optimize recharge periods and also to minimize down time of apparatuses 130. Such performance of battery packs 132 may be achieved due to recharge of battery packs 132 and also due to replacement time of exhausted battery packs 132.

In some embodiments, facility system management unit 140 may provide health and operation history and analytics of each of battery packs 132 to central control unit 101, for instance stored at memory unit 104. Furthermore, health and operation parameters of each of battery packs 132 may be stored and analyzed by central control unit 101. Thus, usage of apparatuses 130 in each local facility 110 may be stored, analyzed and monitored by central control unit 101.

Based on the stored health indications and operation history of each battery pack 132 and of each battery powered apparatus 130, central control unit 101 may provide advance warnings to an operator of local facility 110 and/or to operator of battery powered apparatus 130 that a particular battery pack 132 needs to be replaced shortly. Similarly, central control unit 101 may issue a purchase order for new battery packs, and/or order maintenance service for fixing certain battery packs in a certain facility 110. In some embodiments, central control unit 101 may also issue advance recommendation to replace a particular battery pack 132 with a new one.

For example in a plant having distributed facilities 110 and central control unit 101, such advance warnings, or advance purchase orders, or advance maintenance orders, may be issued to the respective operations unit, either at a local level of facility 110 or at a plant level of monitoring system 100, as the case may be.

Central control unit 101 may further analyze cumulative information of a plurality of battery packs 132 and of plurality activities of plurality of battery powered apparatuses 130 and may recommend changes and/or optimization in algorithms for operating battery powered apparatuses 130 and for recharging policy of battery packs 132. Thus, it may be possible to get more working hours and less charging-time and/or down-time of battery powered apparatuses 130, as well as longer operational time periods of battery packs 132 prior to having to dispose same.

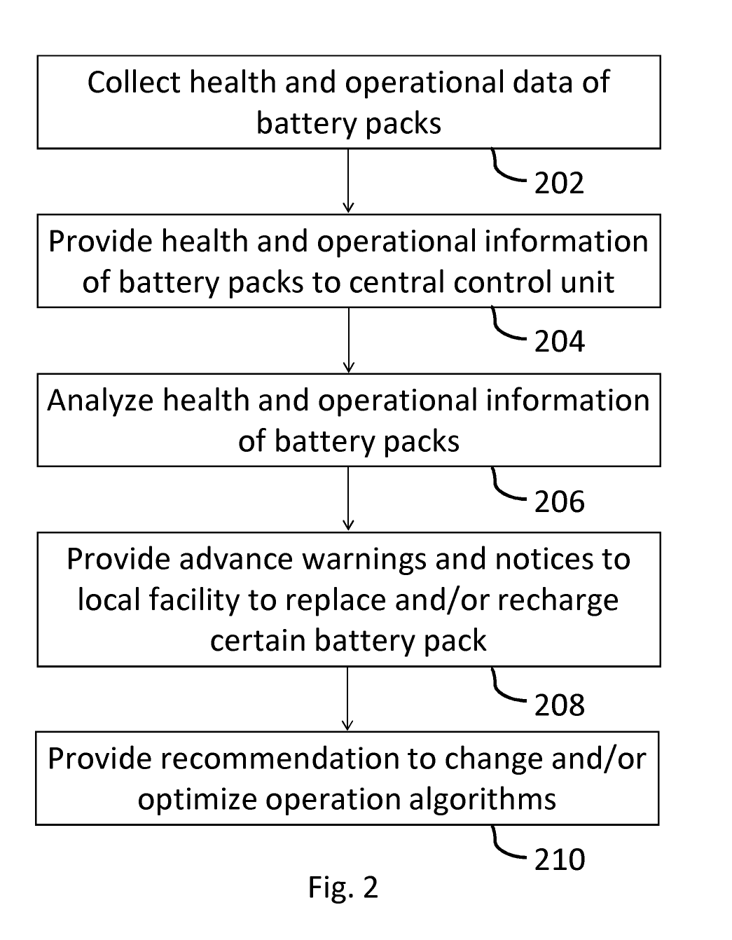

Reference is now made to FIG. 2, which shows a flow diagram of steps performed by monitoring system 100, according to some embodiments of the invention.

It should be noted that initially operational data indicative of battery packs in the management system may be collected 202, for instance by the facility system management units. Health and operational data indicative of battery packs in the management system may then be provided 204 to central control unit.

Next, the central control unit may analyze the operational data 206 indicative of battery packs in the management system. In some embodiments, the central control unit may provide advance warnings 208 and notices to local facility system management units, such as replace and/or recharge a particular battery pack. The central control unit may further provide recommendation 210 to change and/or optimize operation algorithms based on cumulative data, for instance in the storage unit.

According to some embodiments, in addition to monitoring the state of the batteries, the operator may also utilize the monitoring system to manage the monitored facilities. For example, the operator may use the monitoring system to send a signal to a particular battery powered apparatus (e.g., send a signal wirelessly) to shut down or proceed to recharging when an indication of low power is received. Optionally, the operator may control the charging current provided to the batteries if required.

It is appreciated that, while batteries are described above, other means of power storage devices may also be managed in a similar fashion.

Unless explicitly stated, the method embodiments described herein are not constrained to a particular order in time or chronological sequence. Additionally, some of the described method elements may be skipped, or they may be repeated, during a sequence of operations of a method.

Various embodiments have been presented. Each of these embodiments may of course include features from other embodiments presented, and embodiments not specifically described may include various features described herein.

1. A monitoring system for battery powered devices, comprising:
at least one power storage element, configured to power a battery powered device;
a central control unit, operably coupled to the at least one power storage element; and
at least one sensor, operably coupled to the at least one power storage element and configured to measure at least one operational parameter of the at least one power storage element and send the measured at least one parameter to the central control unit,
wherein the central control unit is configured to send control commands to the at least one power storage element, and
wherein the central control unit is configured to control the charging time of the at least one power storage element.

2. The system according to claim 1, wherein the central control unit comprises a computing unit that is configured to allow analysis of information.

3. The system according to claim 2, wherein the central control unit further comprises a memory unit.

4. The system according to claim 1, wherein the at least one sensor comprises a temperature sensor.

5. The system according to claim 4, wherein the at least one sensor further comprises an electric current sensor.

6. The system according to claim 1, further comprising a network connection, configured to allow data transfer between the at least one power storage element and the central control unit.

7. The system according to claim 1, further comprising a user's control terminal capable of displaying monitoring information of the at least one power storage element.

8. The system according to claim 7, wherein the user's control terminal capable of analyzing commands and data entered by the user.

9. The system according to claim 1, wherein the central control unit is further configured to control the charging and discharging current of the at least one power storage element.

10. The system according to claim 1, wherein the central control unit is further configured to provide an indication when the at least one power storage element exceeds predefined parameters.

11. The system according to claim 1, further comprising a management unit operably coupled to the central control unit and to the at least one power storage element, wherein the management unit is configured to allow monitoring of the at least one power storage element.

12. A method for monitoring battery powered devices, the method comprising:
providing at least one power storage element, configured to power a battery powered device;
providing a central control unit, operably coupled to the at least one power storage element;
providing at least one sensor, operably coupled to the at least one power storage element;
measuring parameters of the at least one power storage element;
sending the measured parameters to the central control unit; and
sending control commands to the at least one power storage element,
wherein control commands sent to the at least one power storage element comprises operation orders to modify charging time.

13. The method according to claim 12, further comprising displaying measured parameters to the user.

14. The method according to claim 12, further comprising analyzing data of measured parameters.

15. The method according to claim 12, further comprising measuring temperature with the at least one temperature sensor.

16. The method according to claim 12, wherein the control commands are sent via a network connection.

17. The method according to claim 12, further comprising displaying monitoring information of the at least one power storage element.

18. The method according to claim 12, further comprising analyzing commands and data entered by the user.

19. The method according to claim 12, further comprising controlling the charging and discharging current of the at least one power storage element.

20. The method according to claim 12, further comprising providing an indication when the at least one power storage element exceeds predefined parameters.
